(19) United States
(12) Patent Application Publication
(10) Pub. No.: US 2020/0228664 A1
(43) Pub. Date: Jul. 16, 2020

(54) CONTROLLED DEVICE, COMMUNICATION CONTROL METHOD, AND PROGRAM

(71) Applicant: CASIO COMPUTER CO., LTD., Shibuya-ku, Tokyo (JP)

(72) Inventor: Yoshinori TOMIDOKORO, Higashimurayama-shi, Tokyo (JP)

(73) Assignee: CASIO COMPUTER CO., LTD., Shibuya-ku, Tokyo (JP)

(21) Appl. No.: 16/649,959

(22) PCT Filed: Sep. 21, 2018
(86) PCT No.: PCT/JP2018/035180

§ 371 Date: Mar. 23, 2020

(30) Foreign Application Priority Data
Sep. 25, 2017 (JP) 2017-183221

(51) Int. Cl. H04M 11/00; H04N 5/232; H04W 76/10; H04W 76/30

(52) U.S. Cl. CPC H04M 11/007; H04W 76/30; H04W 76/10; H04N 5/232

(57) ABSTRACT

A controlled device includes a first communicator; a second communicator; a first determiner and a first controller. The first determiner determines whether an instruction of cancelling remote control by a first remote control device is detected based on whether a predetermined signal is received from the first remote control device or whether a predetermined operation is detected by an operation detector which detects a user operation, the first remote control device being communicably connected to the controlled device via the first communicator. The first controller performs control to disconnect communication with the first remote control device via the first communicator and start communication with a second remote control device via the second communicator, in response to determination by the first determiner that the instruction of cancelling the remote control by the first remote control device is detected.

### TECHNICAL FIELD

The present invention relates to a controlled device, a communication control method, and a program.

### BACKGROUND ART

There have been conventionally known the technique that enables to limit and release the function of camera body by the operation from the remote control device, in a camera to which remote control can be performed (for example, Patent Document 1). According to this technique, it is possible to control various functions by the remote control without operating the camera body.

### CITATION LIST

### Patent Literature

Patent Document 1: JP 2015-142183A

### SUMMARY OF INVENTION

### Technical Problem

However, when the camera can be connected to a plurality of types of remote control devices, it has not been possible to promptly and easily switch the connection from one remote control device to another remote control device.

The present invention has been made in consideration of such a problem, and an object of the present invention is to improve the convenience when control is received from a plurality of remote control devices.

### Solution to Problem

The controlled device of the present invention includes: a first communicator; a second communicator; a first determiner that determines whether an instruction of cancelling remote control by a first remote control device is detected based on whether a predetermined signal is received from the first remote control device or whether a predetermined operation is detected by an operation detector which detects a user operation, the first remote control device being communicably connected to the controlled device via the first communicator; and a first controller that performs control to disconnect communication with the first remote control device via the first communicator and start communication with a second remote control device via the second communicator, in response to determination by the first determiner that the instruction of cancelling the remote control by the first remote control device is detected.

### Advantageous Effects of Invention

According to the present invention, it is possible to improve the convenience when control is received from a plurality of remote control devices.

### BRIEF DESCRIPTION OF DRAWINGS

FIG. 1 is a view showing the entire configuration example of a remote control system in the present embodiment.

FIG. 2 is a block diagram showing the functional configuration of a camera in FIG. 1.

FIG. 3 is a flowchart showing communication control processing executed by a controller in FIG. 2.

### DESCRIPTION OF EMBODIMENTS

Hereinafter, embodiments according to the present invention will be described in detail with reference to the accompanying drawings. The present invention is not limited to the illustrated example.

[Configuration of Remote Control System 100]

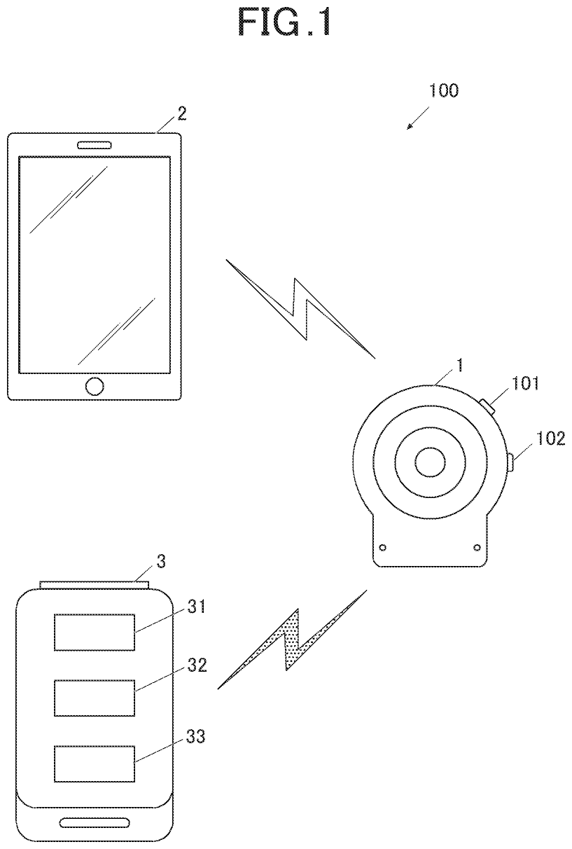

FIG. 1 is a view showing the entire configuration example of a remote control system 100 in the present embodiment.

As shown in FIG. 1, the remote control system 100 is configured by including a camera 1, a smartphone 2, and a remote controller 3. The camera 1 can be wirelessly connected to the smartphone 2 via Wi-Fi (registered trademark) and Bluetooth (registered trademark, for example, Bluetooth 4.0 (Bluetooth Low Energy)), and the camera 1 can be wirelessly connected to the remote controller 3 via Bluetooth (for example, Bluetooth 4.0 (Bluetooth Low Energy)). The camera 1 is a controlled device that receives remote controls from the smartphone 2 and the remote controller 3, and performs imaging operation and the like. The remote control is performed alternatively from the smartphone 2 or the remote controller 3. The remote controller 3 includes a power on/off key 31, a video recording start/end key 32, and a shutter key 33. The control signal based on these operations is transmitted to the camera 1.

(Camera 1)

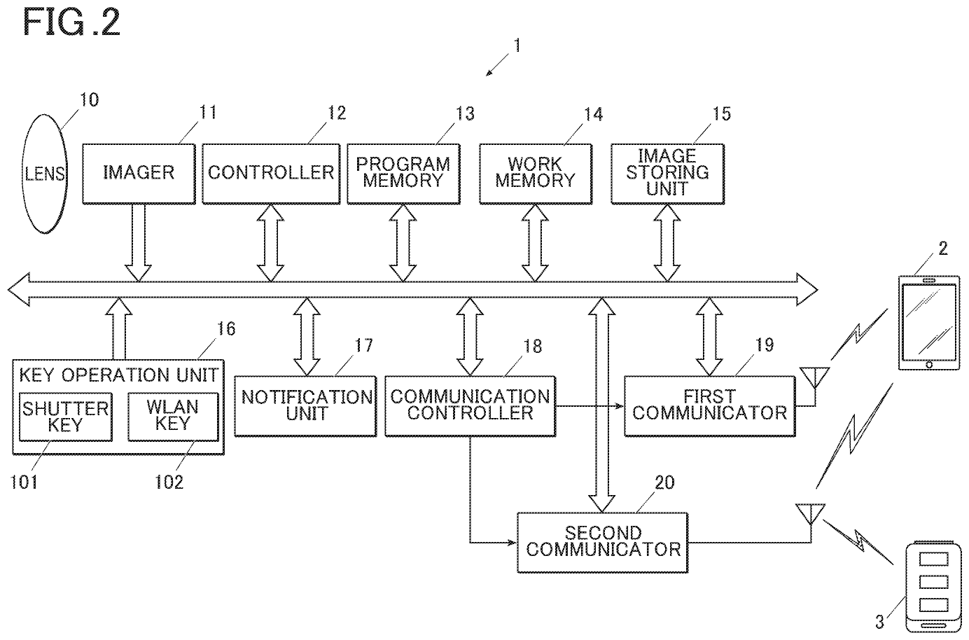

FIG. 2 is a block diagram showing the functional configuration of the camera 1. As shown in FIG. 2, the camera 1 is configured by including an imager 11 that includes a lens 10, a controller 12, a program memory 13, a work memory 14, an image storing unit 15, a key operation unit 16, a notification unit 17, a communication controller 18, a first communicator 19, and a second communicator 20. The units are connected to each other via a bus.

The imager 11 is configured by including the lens 10, imaging elements including the image sensor such as CCD (Charge Coupled Device) and CMOS (Complementary Metal-oxide Semiconductor) not shown in the drawings, an A/D conversion circuit, and the like. The imager 11 converts the optical image that passed through the lens 10 into a two-dimensional image signal with the imaging elements, and obtains image data.

The controller 12 is configured by including a CPU (Central Processing Unit), and the like. The controller 12 performs predetermined calculation and control of each unit by executing various programs stored in the program memory 13. For example, the controller 12 executes after-mentioned communication control processing, and functions as a first determiner, a second determiner, a third determiner and a first controller.

The program memory 13 is configured by including a nonvolatile semiconductor memory, a hard disk, or the like. The program memory 13 stores system programs and various processing programs executed by the controller 12, data necessary for executing these programs, and the like.

The work memory 14 is configured by including a RAM (Random Access Memory) or the like, and provides a working memory space to the controller 12, and temporarily stores data.

The image storing unit 15 is configured by including a flash memory or the like, for example, and stores the image data taken by the imager 11.

The key operation unit 16 includes various function keys including a power key not shown in the drawings, a shutter key 101, and a WLAN (Wireless LAN) key 102. The key operation unit 16 detects the operation performed to each key by the user, and outputs the detection result to the controller 12. The key operation unit 16 functions as an operation detector.

The notification unit 17 is configured by including an LED (Light Emitting Diode), a notification sound output unit that outputs notification sound, a vibration generation unit that generates vibration and the like, for example, and the notification unit 17 performs notification of information to the user.

The communication controller 18 performs switching control of the communication with the smartphone 2 via a first communicator 19 and the communication with the remote controller 3 via a second communicator 20 based on control by the controller 12.

The first communicator 19 is connected to the smartphone 2 via WLAN in accordance with control by the communication controller 18, to receive various control signals from the smartphone 2 and transmit the image data obtained from the imager 11 to the smartphone 2. In the present embodiment, the first communicator 19 performs communication with the smartphone 2 via Wi-Fi. The first communicator 19 functions as a first communicator.

The second communicator 20 performs wireless communication with the smartphone 2, the remote controller 3, and the like by low power communication.

In the present embodiment, the second communicator 20 includes a communicator that performs communication via Bluetooth2.1EDR and a communicator that performs communication via Bluetooth4.0. The communicator via Bluetooth2.1EDR is connected with a corresponding remote controller via Bluetooth2.1EDR in accordance with control by the communication controller 18, and receives various control signals from this remote controller. The communicator via Bluetooth4.0 is connected with the corresponding remote controller 3 via Bluetooth4.0 in accordance with control by the communication controller 18, and receives various control signals from this remote controller 3. The connection with the smartphone 2 is also made in accordance with control by the communication controller 18, and polling processing is periodically performed to the smartphone 2 to wait for reception of the control signal such as a start instruction signal of communication via the first communicator 19 from the smartphone 2. The communicator via Bluetooth2.1EDR and the communicator via Bluetooth4.0 of the second communicator 20 function as a second communicator.

The smartphone 2 includes a display unit and can display the image obtained by imaging by the imager 11. Thus, it is possible to transmit the image data obtained by imaging by the imager 11 from the camera 1 to the smartphone 2 based on the instruction from the smartphone 2. On the other hand, since the remote controller 3 does not include a display unit, transmission of image data from the camera 1 to the remote controller 3 is not performed. Thus, the communication with the smartphone 2 is performed via the first communicator 19 that performs communication by a communication method (in the embodiment, Wi-Fi) capable of large amount of data communication, and the communication with the remote controller 3 is performed by a communication method (in the embodiment, Bluetooth4.0 (Bluetooth Low Energy)) having low communication-related power consumption. When the reception of the start instruction signal of communication from the smartphone 2 is waited, the communication is performed by the communication method having the communication-related power consumption lower than the communication-related power consumption of the first communicator 19 since the polling is performed periodically.

(Smartphone 2)

The smartphone 2 is a first remote control device in which a dedicated application software for remotely controlling the camera 1 (hereinafter, remote control application) is installed. The user can remotely control the camera 1 by the operation to the operation button provided by the remote operation application in the smartphone 2. For example, it is possible to perform remote operations such as remote imaging (imaging instruction of still image, start/end instruction of video recording), image display in the camera 1, switching of on/off of the power, switching of the device which controls the camera 1, and various settings related to the camera 1.

(Remote Controller 3)

The remote controller 3 is a second remote control device that receives a user operation and remotely controls the camera 1.

The remote controller 3 does not include a display unit, and can perform remote operations of only the remote imaging (imaging instruction of still image by detecting the operation to the shutter key 33, start/end instruction of video recording by detecting the operation to the video recording start/end key 32), and switching of on/off of power by detecting the operation to the power on/off key 31.

[Operation of Remote Control System 100]

Next, the operation of remote control system 100 will be described.

When the user turns on the power of the camera 1, activates the remote control application of the smartphone 2 and presses the WLAN key 102, the controller 12 causes the first communicator 19 to have Wi-Fi connection with the smartphone 2 by the communication controller 18, and controls each unit based on the remote control from the smartphone 2 (that is, based on the control signal received from the smartphone 2). The camera 1 switches the remote control device which is the destination of communication connection between the smartphone 2 and the remote controller 3 based on the control signal received from the smartphone 2.

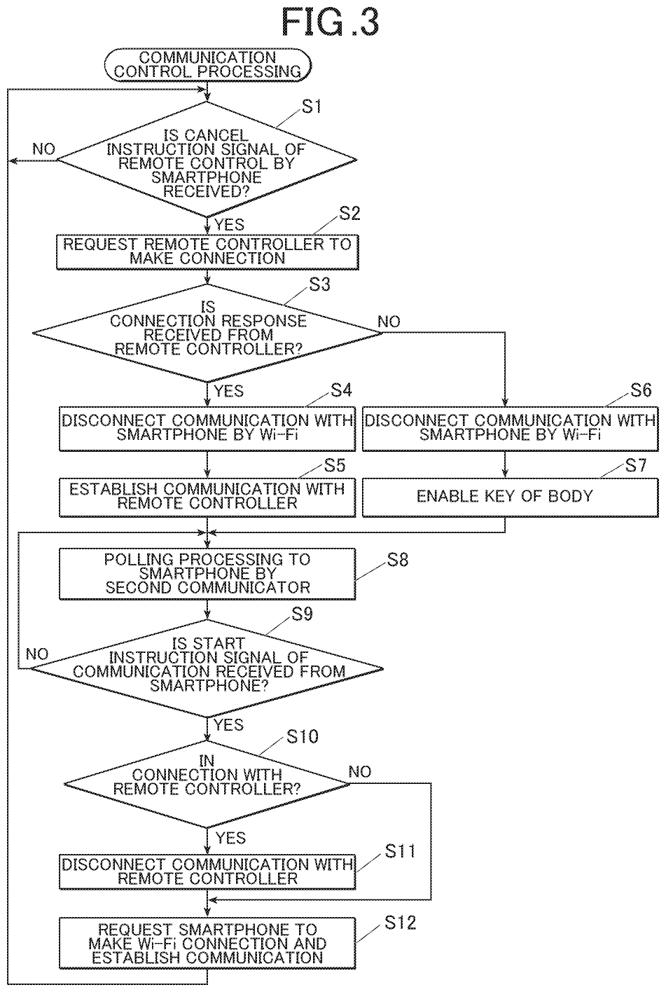

Hereinafter, communication control processing of switching the destination of communication connection in the camera 1 according to the control from the smartphone 2 will be described. FIG. 3 is executed by cooperation between the controller 12 and the program stored in the program memory 13 when the power of the camera 1 is turned on and the camera 1 and the smartphone 2 are in Wi-Fi connection with each other.

First, the controller 12 determines whether a signal instructing cancel of remote control by the smartphone 2 is received from the smartphone 2 via the first communicator 19 (step S1).

In the smartphone 2, during the Wi-Fi connection with the camera 1, an “operate with camera or remote controller” button is displayed on the display unit by the remote control application. When the user touches this button, the smartphone 2 detects the touch, and transmits the signal instructing the cancel of remote control by the smartphone 2 to the camera 1 via Wi-Fi.

If the controller 12 determines that the signal instructing cancel of remote control by the smartphone 2 is received from the smartphone 2 by the first communicator 19 (step S1; YES), in response to this determination, the controller 12 causes the second communicator 20 to perform connection request to the remote controller 3 by the communication controller 18 (step S2).

Next, the controller 12 determines whether the connection response from the remote controller 3 was received by the second communicator 20 (that is, whether the remote controller 3 is in operation) (step S3).

If the controller 12 determines that the connection response from the remote controller 3 was received by the second communicator 20 (that is, the remote controller 3 is in operation) (step S3; YES), in response to this determination, the controller 12 disconnects, by the communication controller 18, the Wi-Fi communication with the smartphone 2 via the first communicator 19 (step S4), causes the second communicator 20 to establish the communication with the remote controller 3 (step S5), and proceeds to step S8.

While the communication with the remote controller 3 by the second communicator 20 is established, the controller 12 controls the camera 1 based on the control signal from the remote controller 3 which is received by the second communicator 20.

On the other hand, if the controller 12 determines that the connection response from the remote controller 3 was not received by the second communicator 20 (that is, the remote controller 3 is not in operation) (step S3; NO), the controller 12 disconnects, by the communication controller 18, the Wi-Fi communication with the smartphone 2 via the first communicator 19 (step S6), enables detection of key operations performed to the key operation unit 16 (step S7), and proceeds to step S8.

The controller 12 controls the camera 1 based on the operation signal detected from the key operation unit 16.

In step S8, the controller 12 causes the second communicator 20 to periodically perform polling processing to the smartphone 2 by the communication controller 18 (step S8), and determines whether the start instruction signal of communication was received from the smartphone 2 (step S9).

In the smartphone 2, when the Wi-Fi connection with the camera 1 is disconnected, a screen notifying the user that the camera 1 was switched to the remote operation by the remote controller 3 or the key operation to the body of camera 1 is displayed on the display unit by the remote control application, and an “operate with smartphone” button for instructing the switching to the remote operation by the smartphone 2 is displayed. When the touch to the “operate with smartphone” button by the user is detected, the smartphone 2 transmits the start instruction signal of communication with the smartphone 2 via Wi-Fi to the camera 1.

If the controller 12 determines that the start instruction signal of communication from the smartphone 2 was detected (received) by the second communicator 20 (step S9; YES), the controller 12 determines whether the camera 1 is communicably connected with the remote controller 3 via the second communicator 20 (step S10). If the controller 12 determines that the camera 1 is not communicably connected with the remote controller 3 (step S10; NO), the controller 12 proceeds to step S12. If the controller 12 determines that the camera 1 is communicably connected with the remote controller 3 (step S10; YES), the controller 12 disconnects, by the communication controller 18, the communication with the remote controller 3 via the second communicator 20 (step S11). Then, the controller 12 causes the smartphone 2 to make Wi-Fi connection via the first communicator 19 to establish the communication with the smartphone 2 (step S12), and returns to step S1.

While the communication with the smartphone 2 by the first communicator 19 is established, the controller 12 controls the camera 1 based on the control signal from the remote controller 3 which was received by the second communicator 20.

The controller 12 repeatedly executes the processes of steps S1 to S12 until the power of the camera 1 is turned off.

As described above, according to the camera 1, the controller 12 determines whether the instruction of cancelling the remote control by the smartphone 2 was detected or not based on whether a predetermined signal was received from the smartphone 2 which is communicably connected to the camera 1 via the first communicator 19. If the controller 12 determines that the instruction of cancelling the remote control by the smartphone 2 was detected, the controller 12 performs control to disconnect the communication with the smartphone 2 via the first communicator 19 and start the communication with the remote controller 3 via the second communicator 20.

Accordingly, by the instruction from the smartphone 2, it is possible to easily switch the camera 1 from the remote control by the smartphone 2 to the remote control by the remote controller 3, and improve the convenience of the camera 1 which receives the remote control from the smartphone 2 and the remote controller 3.

For example, when the controller 12 determines that the instruction of cancelling the remote control by the smartphone 2 was detected, the controller 12 determines whether the remote controller 3 is in operation. When the controller 12 determines that the remote controller 3 is in operation, the controller 12 performs control to disconnect the communication with the smartphone 2 via the first communicator 19 and start the communication with the remote controller 3 via the second communicator 20.

Accordingly, when the instruction of cancelling the remote control is received from the smartphone 2 and the remote controller 3 is in operation, it is possible to automatically switch the camera 1 from the remote control by the smartphone 2 to the remote control by the remote controller 3.

The controller 12 periodically performs polling to the smartphone 2 from the second communicator 20, and when the controller 12 determines that the start instruction signal of communication with the smartphone 2 was received from the second communicator 20 in a state in which the camera 1 is not communicably connected to the smartphone 2 via the first communicator 19, the controller 12 disconnects the communication with the remote controller 3 via the second communicator 20, and controls to start the communication with the smartphone 2 via the first communicator 19.

Accordingly, based on the instruction from the smartphone 2, it is possible to easily switch the camera 1 from the remote control by the remote controller 3 to the remote control by the smartphone 2. Since the polling is performed by a predetermined communication method of the second communicator 20 which has the communication-related power consumption lower than the communication-related power consumption of the first communicator 19, it is possible to suppress the power consumption.

When the instruction of cancelling the remote control by the smartphone 2 is received and the remote controller 3 is not in operation, the controller 12 disconnects the communication with the smartphone 2 by the first communicator 19, and controls the camera 1 based on the operation detected by the key operation unit 16.

Accordingly, when the instruction of cancelling the remote control is received from the smartphone 2, and the remote controller 3 is not in operation, it is possible to automatically switch the camera 1 from the remote control by the smartphone 2 to the control based on the operation detected by the key operation unit 16 of the body of the camera 1.

The first communicator 19 transmits the image taken by the imager 11 on the communication with the smartphone 2. The second communicator 20 does not transmit the image taken by the imager 11 on the communication with the remote controller 3. Accordingly, the user can confirm the image obtained by the imager 11 on the smartphone 2 having the display unit. It is possible to cause the image not to be transmitted to the remote controller 3 not having the display unit.

The contents of description in the above embodiment are preferred examples of a remote control system according to the present invention, and the present invention is not limited to this embodiment.

For example, in the above embodiment, the controller 12 determines whether the instruction of cancelling the remote control by the smartphone 2 was detected or not based on whether the signal instructing the cancel of the remote control from the smartphone 2 was received in step S1 in FIG. 3. However, whether the instruction of cancelling the remote control by the smartphone 2 was detected may be determined by whether the pressing operation was continuously performed to the WLAN key 102 for a first predetermined period, for example. Thus, even in a situation where the direct operation to the smartphone 2 by the user is difficult, it is possible to easily switch the camera 1 from the remote control by the smartphone 2 to the remote control by the remote controller 3 with an easy operation to the camera body, which enables improvement of the convenience of the camera 1 that receives the remote control from the smartphone 2 and the remote controller 3.

The above embodiment has been described that, in step S9 of FIG. 3, the controller 12 determines whether the start instruction signal of the communication from the smartphone 2 was received, and in response to the determination that the start instruction signal of the communication from the smartphone 2 was received, the controller 12 executes the processes of steps S10 to S12 to switch the device which controls the camera 1 to the smartphone 2. However, for example, the controller 12 may determine whether the instruction of starting the communication by the smartphone 2 was detected based on whether the pressing operation was continuously performed to the WLAN key 102 for a second predetermined period shorter than the first predetermined period (fourth determiner). In response to the determination that the instruction of starting the communication by the smartphone 2 was detected, the controller 12 may execute the processes of steps S10 to S12 in FIG. 3. Thus, even in a situation where the direct operation to the smartphone 2 by the user is difficult, it is possible to easily switch the camera 1 from the remote control by the remote controller 3 to the remote control by the smartphone 2 with an easy operation to the camera body, which enables improvement of the convenience of the camera 1 that receives the remote control from the smartphone 2 and the remote controller 3.

In the above embodiment, the controller 12 switches the remote control by the smartphone 2 and the remote control by the remote controller 3 in response to user's intentional operation such as the operation to the smartphone 2 by the user, pressing operation to the WLAN key 102 or the like. However, the present invention is not limited to this, and the controller 12 may automatically switch the camera 1 from the remote control by the remote controller 3 to the remote control by the smartphone 2 (or from the remote control by the smartphone 2 to the remote control by the remote controller 3) by the change in communication environment between the camera 1 and the smartphone 2 or the remote controller 3 (second controller). By such a configuration, it is possible to improve the convenience of the camera 1 even when the connection between the camera 1 and the smartphone 2 or the remote controller 3 is interrupted unrelated to user's intention.

The above embodiment has been described by taking, as an example, a case where the first communicator of the present invention is the communicator via Wi-Fi, and the second communicator is the communicator via Bluetooth®, the communication methods of the first communicator and the second communicator are not limited to the above embodiment, and may be other communication methods.

The above embodiment has been described by taking, as an example, a case where the controlled device is the camera 1. However, the controlled device is not limited to the camera, and may be other electronic devices.

The above embodiment has been described by taking, as an example, a case where the first remote control device is the smartphone. However, the first remote control device may be other terminal devices such as a tablet.

In addition, for example, though the above description discloses an example in which a hard disk, a semiconductor nonvolatile memory, or the like is used as a computer readable medium of the program according to the present invention, the present invention is not limited to this example. As other computer readable mediums, portable storage mediums such as a CD-ROM can be applied. A carrier wave is also applied as the medium to provide data of the program according to the present invention via the communication lines.

As for the other detailed configurations and detailed operations of devices forming the remote control system, modifications can be made as needed without departing from the scope of the present invention.

Although several embodiments of the present invention have been described, the scope of the present invention is not limited to the above described embodiments and includes the scope of the present invention that is described in the claims and the equivalents thereof.

The entire disclosure of Japanese Patent Application No. 2017-183221 (filed on Sep. 25, 2017) is incorporated herein by reference in its entirety.

### INDUSTRIAL APPLICABILITY

The present invention can be used for a controlled device that receives control from a plurality of remote control devices.

### REFERENCE SIGNS LIST

100 remote control system
1 camera
10 lens
11 imager
12 controller
13 program memory
14 work memory
15 image storing unit
16 key operation unit
101 shutter key
102 WLAN key
17 notification unit
18 communication controller
19 first communicator
20 second communicator
2 smartphone
3 remote controller

1. A controlled device comprising:
a first communicator;
a second communicator;
a first determiner that determines whether an instruction of cancelling remote control by a first remote control device is detected based on whether a predetermined signal is received from the first remote control device or whether a predetermined operation is detected by an operation detector which detects a user operation, the first remote control device being communicably connected to the controlled device via the first communicator; and
a first controller that performs control to disconnect communication with the first remote control device via the first communicator and start communication with a second remote control device via the second communicator, in response to determination by the first determiner that the instruction of cancelling the remote control by the first remote control device is detected.

2. The controlled device according to claim 1, further comprising a second determiner that determines whether the second remote control device is in operation,
wherein the first controller performs the control to disconnect the communication with the first remote control device via the first communicator and start the communication with the second remote control device via the second communicator, in response to determination by the second determiner that the second remote control device is in operation.

3. The controlled device according to claim 2, wherein, in response to the determination by the first determiner that the instruction of cancelling the remote control by the first remote control device is detected and determination by the second determiner that the second remote control device is not in operation, the first controller disconnects the communication with the first remote control device via the first communicator, and controls the controlled device based on an operation detected by the operation detector.

4. The controlled device according to claim 1, further comprising a third determiner that determines whether a start instruction signal of the communication with the first remote control device using the first communicator is received,
wherein the first controller performs control to disconnect the communication with the second remote control device via the second communicator and start the communication with the first remote control device via the first communicator, in response to determination by the third determiner that the start instruction signal of the communication with the first remote control device using the first communicator is received in a state in which the first remote control device is not communicably connected to the controlled device via the first communicator.

5. The controlled device according to claim 4, wherein the start instruction signal is received via the second communicator which has communication-related power consumption lower than communication-related power consumption of the first communicator.

6. The controlled device according to claim 1, further comprising a fourth determiner that determines whether a start instruction signal of the communication with the first remote control device using the first communicator is detected by the operation detector,
wherein the first controller performs control to disconnect the communication with the second remote control device via the second communicator and start the communication with the first remote control device via the first communicator, in response to determination by the fourth determiner that the start instruction signal of the communication with the first remote control device using the first communicator is detected in a state in which the first remote control device is not communicably connected to the controlled device via the first communicator.

7. The controlled device according to claim 1, further comprising an imager,
wherein the first communicator transmits an image taken by the imager on the communication with the first remote control device, and
wherein the second communicator does not transmit the image taken by the imager on the communication with the second remote control device.

8. A controlled device comprising:
a first communicator;
a second communicator; and
a second controller that performs control to disconnect communication with a first remote control device via the first communicator and start communication with a second remote control device via the second communicator based on change in a situation of the communication with the first remote control device which is communicably connected to the controlled device via the first communicator.

9. A communication control method in a controlled device including a first communicator and a second communicator, the method comprising:
determining whether an instruction of cancelling remote control by a first remote control device is detected based on whether a predetermined signal is received from the first remote control device or whether a predetermined operation is detected by an operation detector which detects a user operation, the first remote control device being communicably connected to the controlled device via the first communicator; and
performing control to disconnect communication with the first remote control device via the first communicator and start communication with a second remote control device via the second communicator, in response to determination that the instruction of cancelling the remote control by the first remote control device is detected.

10. A communication control method in a controlled device including a first communicator and a second communicator, the method comprising performing control to disconnect communication with a first remote control device via the first communicator and start communication with a second remote control device via the second communicator based on change in a situation of the communication with the first remote control device which is communicably connected to the controlled device via the first communicator.

11. A non-transitory computer readable storage medium storing a program causing a computer that is used for a controlled device including a first communicator and a second communicator to function as:
a determiner that determines whether an instruction of cancelling remote control by a first remote control device is detected based on whether a predetermined signal is received from the first remote control device or whether a predetermined operation is detected by an operation detector which detects a user operation, the first remote control device being communicably connected to the controlled device via the first communicator; and
a first controller that performs control to disconnect communication with the first remote control device via the first communicator and start communication with a second remote control device by the second communicator, in response to determination by the determiner that the instruction of cancelling the remote control by the first remote control device is detected.

12. A non-transitory computer readable storage medium storing a program causing a computer that is used for a controlled device including a first communicator and a second communicator to function as a second controller that performs control to disconnect communication with a first remote control device via the first communicator and start communication with a second remote control device via the second communicator based on change in a situation of the communication with the first remote control device which is communicably connected to the controlled device via the first communicator.
